(19) United States
(12) Patent Application Publication
(10) Pub. No.: US 2009/0109678 A1
(43) Pub. Date: Apr. 30, 2009

(54) LIGHT SOURCE ASSEMBLY

(75) Inventors: Chih-Peng Hsu, Chu-Nan (TW); Tse-An Lee, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/135,864

(22) Filed: Jun. 9, 2008

(30) Foreign Application Priority Data
Oct. 24, 2007 (CN) 200710202230.6

(51) Int. Cl. F21V 23/02; F21V 5/00

(52) U.S. Cl. 362/268; 362/311.14

(57) ABSTRACT

In one embodiment, an exemplary light source assembly includes a light source device, a optical component, and a light pervious filling layer interposed between the light source and the optical component. The light source includes a light pervious cover. The light pervious filling layer can reduce a refraction loss and reflection loss of light.

### BACKGROUND

1. Technical Field

The present invention generally relates to a light source assembly and, more specifically, relates to a light source assembly including a solid state light source.

2. Discussion of Related Art

Currently, light emitting diodes (LEDs) are widely employed in various applications such as backlight assemblys for liquid crystal displays (LCD). Optical components are required in most LED applications. For example, a light guide plate is employed and serves as the optical component to convert the light emitted from an LED into a surface light.

Generally, the light source is arranged adjacent to the light guide plate. An air gap exists between the LED and the light guide plate. Light emitted from the light source passes through the air gap and then enters into the light guide plate. However, the refractive index of the light guide plate is greater than that of air. Thus, reflection and refraction occurs in the interface between the air gap and the light guide plate, which compromises the light entering into the light guide plate.

What is needed, therefore, is a light source assembly with reduced reflection and refraction loss and has an improved light transmission rate.

### SUMMARY

In one embodiment, an exemplary light source assembly includes a light source device, a optical component, and a light pervious filling layer interposed between the light source and the optical component. The light source includes a light pervious cover.

This and other features and advantages of the present invention as well as the preferred embodiments thereof and a cleaning apparatus in accordance with the invention will become apparent from the following detailed description and the descriptions of the drawings.

### BRIEF DESCRIPTION OF THE DRAWINGS

Many aspects of the present invention can be better understood with reference to the following drawings. The components in the drawings are not necessarily drawn to scale, the emphasis instead being placed upon clearly illustrating the principles of the present invention.

FIG. 1 illustrates a light source assembly in accordance with a first embodiment.

FIG. 2 is an exploded view of the light source assembly of FIG. 1.

FIG. 3 illustrates a light path of light emitted from the light source assembly of FIG. 1.

FIG. 4 illustrates a light source assembly in accordance with a second embodiment.

FIG. 5 illustrates a light source assembly in accordance with a third embodiment.

FIG. 6 is an exploded schematic view of FIG. 4.

### DETAILED DESCRIPTION OF EXEMPLARY EMBODIMENTS

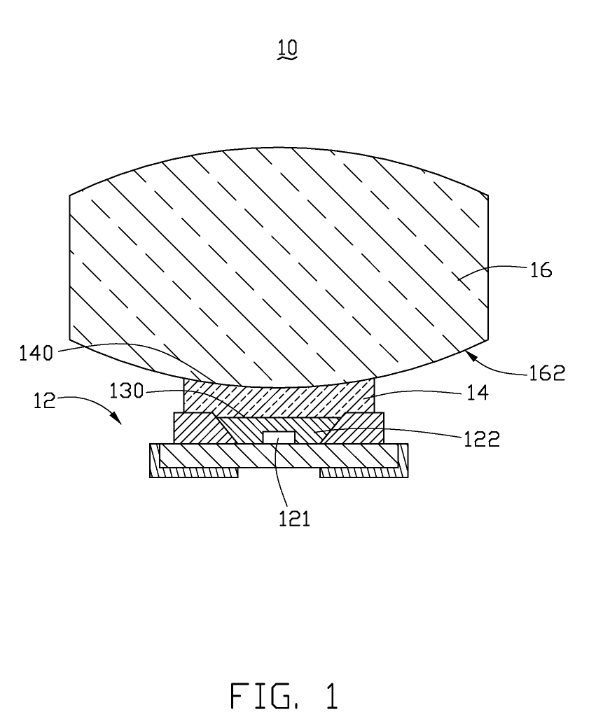

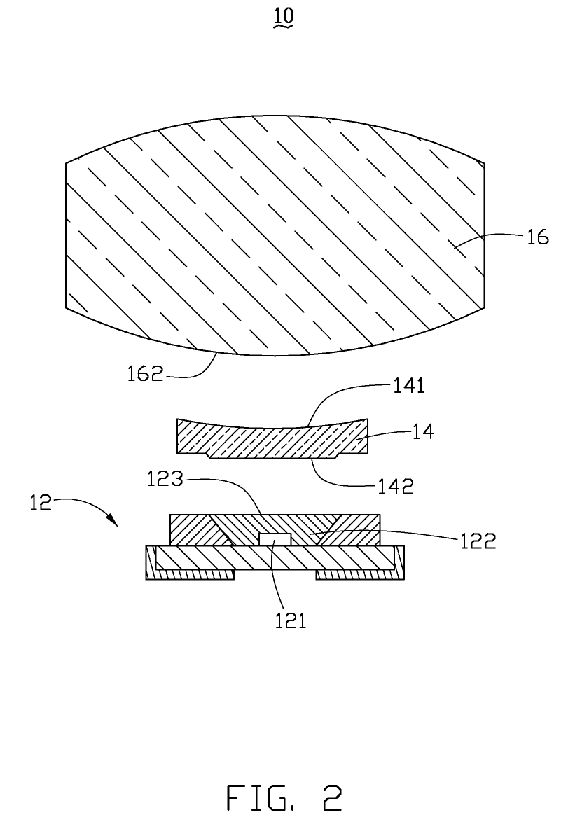

Referring to FIGS. 1 and 2, a light source assembly 10 in accordance with a first embodiment includes a light source device 12, a light pervious filling layer 14, and a optical component 16. The light source device 12 includes a light emitting element 121 and a light pervious cover 122. The light pervious filling layer 14 is interposed between the light pervious cover 122 and the optical component 16.

The light emitting element 121 is a solid state light source such as a light emitting diode chip (LED), or a laser diode. The light pervious cover 122 encloses the light emitting member 121. The light pervious cover 122 includes a light emission surface 123. The light pervious cover 122 can be made of a transparent material selected from a group consisting of glass, silicone, and transparent silicone rubber, transparent resin such as epoxy resin and polymethyl methacrylate (PMMA).

The optical component 16 is configured for processing light emitted from the light pervious filling layer 14 according to different applications' demand. For example, the optical component 16 can be a lens, color filter, transparent plate with opaque pattern formed thereon, and combination thereof. The lens can be used to diffuse or converge light. The color filter can be used to filter light having a certain wave length. The transparent plate can display a certain pattern. In the present embodiment, the optical component 16 is a lens and has a light incidence surface 162.

The light pervious filling layer 14 includes two opposite surfaces 141, 142. The light pervious filling layer can be made of a transparent flexible material selected form a group consisting of silicone, transparent silicone rubber, thermoplastic polyurethane, and polyvinyl chloride. The light pervious filling layer 14 is soft and flexible enough that the two opposite surfaces 141, 142 can be easily transformed, especially when pressure is applied between the light pervious cover 122 and the optical component 16, to conform to the light emission surface 123 and the light emission surface 162 respectively, in other words, the light pervious filling layer 14 fully fills interstices between the light pervious cover 122 and the optical component 16. Preferably, The light pervious filling layer 14 includes at least one type of fluorescent powder or diffuser distributed therein. The fluorescent powder or diffuser facilitate light scattering in the light pervious filling layer 14 thereby improving a uniformity of light extracted from the light pervious filling layer 14.

The light pervious cover 122 and the light pervious filling layer 14 define a first interface 130 therebetween. The light pervious filling layer 14 and the optical component 16 define a second interface 140 therebetween. The light pervious cover 122 has a refractive index of n_{L}, the light pervious filling layer 14 has a refractive index of n_{F}, and the optical component 16 has a refractive index of n_{G}. A light transmission rate of a light beam at the first interface 130 is T_{LF}, and a light reflection rate at the first interface 130 is R_{LF}. A light transmission rate at the second interface 140 is T_{FG}, and a light reflection rate at the second interface 140 is R_{FG}.

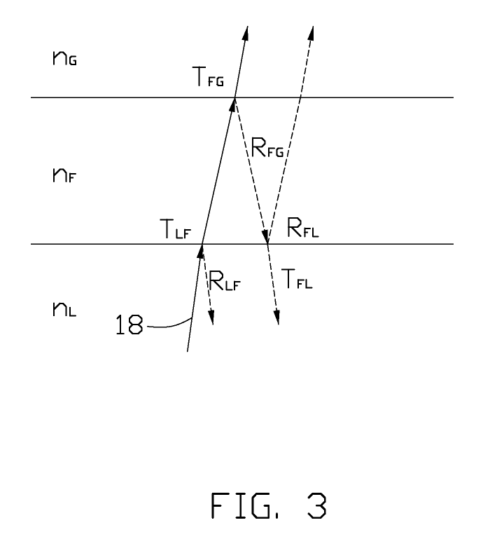

FIG. 3 illustrates a light path of a light beam 18 passing through the light source assembly 10. The light beam 18 is reflected sequentially at the first interface 130 and the second interface 140. A total light transmission rate T of the light beam 18 from the light pervious cover 122 to the optical component 16 can be calculated using the following formula:

$$T = {T}_{LF} {T}_{FG} \frac{1}{1 - {R}_{LF} {R}_{FG}}$$

T is in positive correlation with the relative refractive index at the two boundaries. In other words, the more n_{L}/n_{F} and n_{F}/n_{G} are close to 1, the more T is close to 1. In order to improve the total light transmission rate T, most preferably the refractive index n_{L} of the light pervious cover 122, the refractive index n_{F} of the light pervious filling layer 14, and the refractive index n_{G} of the optical component 16 satisfy an equation n_{L}=n_{F}=n_{G}. When the equation is satisfied, the total light transmission rate T is equal to 1, that is, one hundred percent of the light beam 18 enters the optical component 16. When refractive index n_{L} of the light pervious cover 122 does not equal the refractive index n_{G} of the optical component 16, then the refractive index n_{F} of the light pervious filling layer 14 should satisfy an equation n_{L}<n_{F}<n_{G}, and preferably, the refractive index n_{F} of the light pervious filling layer 14 satisfies an equation n_{F}=\sqrt{n_{L}n_{G}}. Compared to when there is only air between the light pervious cover 122 and the optical component 16, the total light transmission rate T is greatly improved.

It is understood that, during manufacturing of the light source assembly 10, The light pervious filling layer 14 may be preformed on the light-emitting portion 122 prior to assembling of the light source assembly 10. In other embodiments, the light pervious filling layer 14 may be preformed on the optical component 16 prior to assembling the light source assembly 10. Still in other embodiments, the light pervious filling layer 14 may be divided into a first portion and a second portion. The first portion is preformed on the light pervious cover 122, and the second portion is preformed on the optical component 16. If the material of the light pervious filling layer 14 and the light pervious cover 122 are the same, the light pervious filling layer 14 and the light pervious cover 122 can be integrally formed. When the light source device 12 and the optical component 16 are assembled together, the light pervious filling layer 14 is interposed between the light source device 12 and the optical component 16.

As mentioned above, the light pervious filling layer 14 can reduce reflection and refraction loss when the light beam 18 enters the optical component 16. In addition, a large divergent angle and improved light uniformity may be achieved. If the refractive indexes of the light-emitting portion 122, the light pervious filling layer 14 and the optical component 16 are the same or similar, the advantages of the light source assembly 10 are more significant.

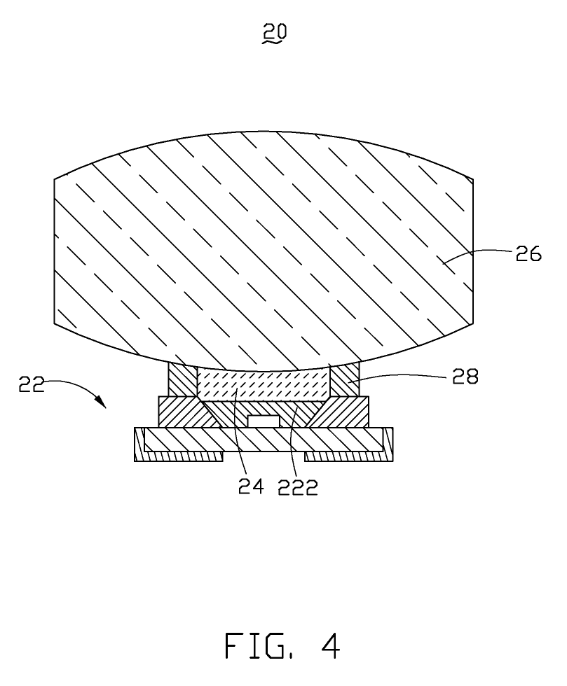

Referring to FIG. 4, a light source assembly 20 in accordance with a second embodiment includes a light source device 22, a light pervious filling layer 24, a optical component 26, and a gasket 28. The light source device 22 includes a light pervious cover 222. The gasket 28 is interposed between the light source device 22 and the optical component 26 thereby defining a sealed receiving space between the light source device 22 and the optical component 26. The receiving space is opposite to the light pervious cover 222. The light pervious filling layer 24 is filled in the receiving space. The light pervious filling layer 24 can be transparent liquid with high refractive index such as organic silicone oil, alcohols having a carbon atom number greater than five, and esters having a carbon atom number greater than five. The gasket 28 can be made of a flexible material such as rubber. The optical component 26 can be selected from a group consisting of lens, color filter, transparent plate with opaque pattern formed thereon and light guide plate. The refractive index of the light pervious cover 222, the refractive index of the light pervious filling layer 24, and the optical component 26 is similar to that of the light source assembly 10. In the second embodiment, the light pervious filling layer 24 is made of liquid material. However, it is understood that the light pervious filling layer 24 can also be flexible solid state material.

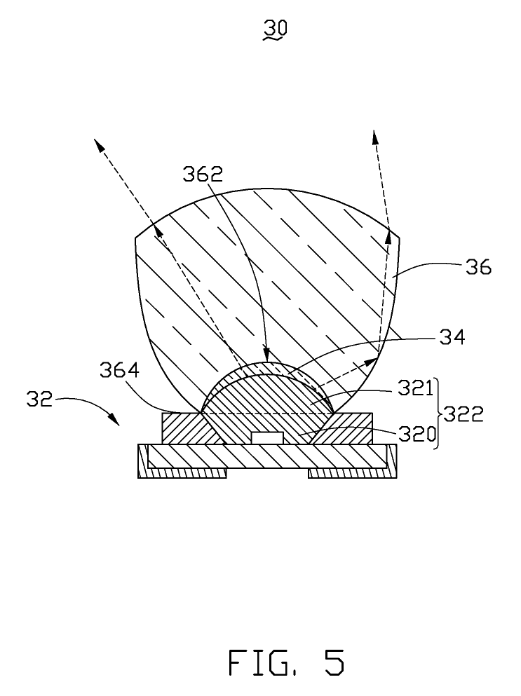

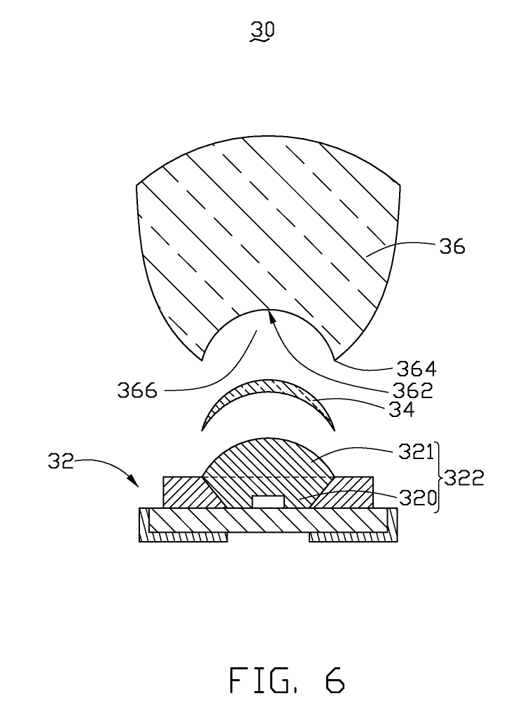

Referring to FIGS. 5 and 6, a light source assembly 30 in accordance with a third embodiment includes a light source device 32, a light pervious filling layer 34 and a optical component 36. The light source device 32 includes a light pervious cover 322. The light pervious cover 322 includes a base portion 320 and a hemispherical convex structured light pervious cover 321. The light pervious filling layer 34 is interposed between the light source device 32 and the optical component 36.

The optical component 36 includes a concave surface 362 opposite to the light source device 32. The concave surface 362 has an edge 364. When the optical component 36 is assembled together with the light source device 32, the edge 364 is in tightly contact with the light source device 32; the concave surface 362 thereby defines a sealed receiving space 366 between the light source device 32 and the optical component 36. The receiving space 366 is opposite to the light pervious cover 322. The light pervious filling layer 34 is filled in the sealed receiving space 366.

In the third embodiment, the light pervious cover 321 is received in the receiving space too. The hemispherical convex structured light pervious cover 321 can improve a light scattering angle of the light source device 32 thereby increasing distribution uniformity of light beams in the optical component 36. Furthermore, the light pervious cover 321 is received in the optical component 36; therefore, almost all the light emitted from the light pervious cover 322 enters the optical component 36. It is understood that the light pervious cover 321 can also be cylinder shaped, prism shaped, cone shaped, cone-frustum shaped, and the light pervious filling layer 34 can be made of a solid state transparent material or a liquid state transparent material.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A light source assembly, comprising:
a light source device comprising a light pervious cover;
an optical component; and
a light pervious filling layer interposed between the light source device and the optical member.

2. The light source assembly as claimed in claim 1, wherein a refractive index of the light pervious filling layer is defined by the following formula n_{L}≦n_{F}≦n_{G.}, wherein n_{L} represents the refractive index of the light pervious cover, n_{F} represents the refractive index of the light pervious filling layer, and n_{G} represents the refractive index of the optical component.

3. The light source assembly as claimed in claim 2, wherein the refractive index of the light pervious filling layer is defined by the following formula n_{F}=\sqrt{n_{L}n_{G}}.

4. The light source assembly as claimed in claim 1, wherein the optical component is selected from the group consisting of a lens, a color filter, and a transparent plate with opaque pattern formed thereon.

5. The light source assembly as claimed in claim 1, wherein the light pervious filling layer comprises fluorescent powders or diffusers distributed therein.

6. The light source assembly as claimed in claim 1, wherein the light pervious filling layer is flexible.

7. The light source assembly as claimed in claim 6, wherein the light pervious filling layer is comprised of a material selected from the group consisting of silicone, silicone rubber, thermoplastic polyurethane, and polyvinyl chloride.

8. A light source assembly, comprising:
a light source comprising a light pervious cover;
an optical component, wherein the light pervious cover and the optical component cooperatively defines a receiving space therebetween; and
a light pervious filling layer filled in the receiving space.

9. The light source assembly as claimed in claim 8, wherein a refractive index of the light pervious cover is n_{L}, a refractive index of The light pervious filling layer is n_{F}, and a refractive index of the optical component is n_{G}, n_{L}≦n_{F}≦n_{G}.

10. The light source assembly as claimed in claim 9, wherein n_{F}=\sqrt{n_{L}n_{G}}.

11. The light source assembly as claimed in claim 8, wherein the optical component is selected from a group consisting of lens, color filter, transparent plate with opaque pattern formed thereon and light guide plate.

12. The light source assembly as claimed in claim 8, wherein the light pervious filling layer comprises fluorescent powders distributed therein.

13. The light source assembly as claimed in claim 8, wherein the receiving space is a sealed space facing the light pervious filling layer.

14. The light source assembly as claimed in claim 13, wherein the light pervious filling layer is comprised of a material is selected from the group consisting of silicone, transparent silicone rubber, thermoplastic polyurethane, and polyvinyl chloride.

15. The light source assembly as claimed in claim 8, wherein the light pervious filling layer is comprised of a liquid material.

16. The light source assembly as claimed in claim 8, wherein the liquid material is selected from the group consisting of organic silicone oil, alcohols having a carbon atom number of greater than five, and esters having a carbon atom number of greater than five.

17. The light source assembly as claimed in claim 8, further comprising a gasket disposed between the light source and the optical component, the gasket, the light source and the optical component cooperatively defining receiving space.

18. The light source assembly as claimed in claim 8, wherein the optical component comprises a concave surface facing the light pervious covercover.

19. A light source assembly, comprising:
a light source device comprising a light emitting chip and a light pervious cover covering the light emitting chip;
an optical lens; and
a light pervious layer interposed between and brought into contact with the light pervious cover and the optical lens, a refractive index of the light pervious layer being not greater than a refractive index of the optical lens and not less than a refractive index of the light pervious cover.

20. The light source assembly as claimed in claim 19, wherein the refractive index of the light pervious layer is approximately equal to the square root of the product of the refractive index of the optical lens and the refractive index of the light pervious cover.
